(19) United States
(12) Patent Application Publication
(10) Pub. No.: US 2013/0262879 A1
(43) Pub. Date: Oct. 3, 2013

(54) SECURE TYPE STORAGE DEVICE AND INFORMATION SECURITY SYSTEM

(71) Applicant: En-Min Jow, (US)

(72) Inventor: En-Min Jow, (US)

(73) Assignee: Aptos Technology Inc., Hsinchu County (TW)

(21) Appl. No.: 13/433,306

(22) Filed: Mar. 29, 2012

(51) Int. Cl. G06F 21/24; G06F 12/14

(52) U.S. Cl. 713/193

(57) ABSTRACT

A secure type storage device applies to data link with a mainframe, wherein the memory module thereof includes hidden and open storage spaces, for storing encrypted data and a file allocation table, respectively; the file allocation table registering storage location and property of the encrypted data accepts external queries, but the encrypted data does not be accessed through direct link; the secure type storage device and management software of the mainframe jointly implement the authentication process, respond the requirement issued by the mainframe after the read/write authorization is produced, access the hidden storage space, and decrypt and output the encrypted data to the mainframe, or receive and encrypt external information to store in the hidden storage space; thus, through the secure type storage device, the storage details is free checked, but the information does not be accessed arbitrarily, to prevent information from being arbitrarily modified or copied and spread.

### BACKGROUND OF THE INVENTION

(a) Field of the invention

The present invention relates to a storage device, especially to a secure type storage device and an information security system.

(b) Description of the Prior Art

With the integration of electronic devices becomes increasingly diversified, the demand for the internal memory capacity is increasingly. The flash memory card is widely used as a storage device, which stores information through non-volatile memory, in a small size, with low power consumption and stable and fast read rates, and a variety of electronic devices use this storage device to expand the memory capacity.

If the digital data within the storage device has confidential nature, or subjects to copyright protection, which must have security procedures to restrict user access rights, and to prevent data from being arbitrarily modified or copied and spread.

The security methods of General storage device include the following two ways. The first way is to encrypt the security data, in which the storage device and the mainframe have separate keys, after cross validation between keys of two sides, the encrypted data is decrypted, and then the mainframe outputs the physical data. The second method is to verify the identification numbers of the mainframe and the storage device, to confirm the access permissions for the mainframe to the storage device, and then the mainframe accesses the security information after validation.

Although data encryption and identity verification can provide basic protection, the liquidity of the network is continuously improved, thus the security information is cracked, the risk of the information being arbitrarily modified or copied and spread is increased, and the intellectual property of the owner of the information is damaged, while the individual faces the risk of privacy exposure. Therefore, to enhance the authentication mechanism for the security information is indeed necessary.

Meanwhile, among the existing information security mechanism, if the user does not have access rights, the internal storage details can not be checked. Once individuals have too many storage devices and make the best storage device classification management, it will be difficult to identify the contents of internal storage for each device, and the use distress is caused.

In view of the above problems, the inventor provides the present invention to improve the applicability of the storage device, to strengthen the storage device's security features, and to provide end users with more comprehensive application protection.

### SUMMARY OF THE INVENTION

Therefore, the main object of the present invention is to provide a secure type storage device and an information security system, in which the memory module is divided into hidden storage space and open storage space, for respectively storing encrypted data and a file allocation table; the storage details in the open storage space is free checked, but the encrypted data does not be accessed through direct connection, after the management software of the mainframe implements the authentication process, and acquires the read/write authorization, the hidden storage space can be accessed, thus, the applicability of the information storage device is improved, and the information is prevented from being arbitrarily modified or copied and spread.

Another object of the present invention is to provide a secure type storage device and an information security system, through the installed management software of the mainframe and the storage device jointly completing the authentication process, and the management of data accessing, the information security level is enhanced.

Yet another object of the present invention is to provide a secure type storage device and an information security system, through storing the read/write times applying to the hidden storage space, and prohibiting the hidden storage space from being continuously accessed when the read/write times reach preset limits, the information security is further protected.

Still another object of the present invention is to provide a secure type storage device and an information security system, through providing an authorization and authentication chip, for integrating the authentication and authorization module, the encryption/decryption module and the hidden storage space, and for isolating general mainframes finding the data of the hidden storage space, the information security is comprehensively protected.

For achieving the above objects, the present invention discloses a secure type storage device applying to data connection with a mainframe, in which the mainframe is installed with management software to jointly implement an authentication process with the secure type storage device. The secure type storage device includes a memory module, an authentication and authorization module, a read and write control module, and an encryption/decryption module. The memory module includes hidden storage space and open storage space, in which the hidden storage space coordinates to store encrypted data, and the open storage space coordinates to store a file allocation table registering the storage location and property of the encrypted data. The authentication and authorization module is used for data link with the mainframe, and coordinating with the management software to perform the authentication process, to produce a read/write authorization. The read and write control module, in accordance with the read/write authorization, responds the requirement of the mainframe, and issues a read out command and a write in command to the hidden storage space. The encryption/decryption module is coupled between the hidden storage space and the read and write control module, for responding the read out command, and decrypting and outputting the encrypted data at the hidden storage space to the mainframe through the read and write control module, and for responding the write in command, receiving and encrypting the external information output from the mainframe, and storing in the hidden storage space, and the read and write control module updates the file allocation table in accordance with the data change at the hidden storage space.

The present invention further discloses an information security system including a mainframe and a secure type storage device. The mainframe is installed with management software to implement an authentication process. The secure type storage device having data link with the mainframe includes a memory module, an authentication and authorization module, a read and write control module, and an encryption/decryption module. The memory module includes hidden storage space and open storage space, in which the hidden storage space coordinates to store encrypted data, and the open storage space coordinates to store a file allocation table registering the storage location and property of the encrypted data. The authentication and authorization module is used for data link with the mainframe, and coordinating with the management software to perform the authentication process, to produce a read/write authorization. The read and write control module, in accordance with the read/write authorization, responds the requirement of the mainframe, and issues a read out command and a write in command to the hidden storage space. The encryption/decryption module is coupled between the hidden storage space and the read and write control module, for responding the read out command, and decrypting and outputting the encrypted data at the hidden storage space to the mainframe through the read and write control module, and for responding the write in command, receiving and encrypting the external information output from the mainframe, and storing in the hidden storage space, and the read and write control module modifies the file allocation table in accordance with the data change at the hidden storage space.

For a specific embodiment, the hidden storage space stores the read/write times for the read and write control module applying to the hidden storage space, when the read/write times reach preset limits, the read and write control module cancels the read/write authorization, and prohibits the mainframe from accessing to the hidden storage space.

For a specific embodiment, the secure type storage device further includes an authorization and authentication chip, in which the authentication and authorization module, the encryption/decryption module and the hidden storage space integrate on the authorization and authentication chip.

The above summary and the following detailed description and drawings are the ways, means and effects adopted for further describing the intended purpose of the present invention. The other objects and advantages of the present invention will be described in the following description and drawings.

### BRIEF DESCRIPTION OF THE DRAWINGS

FIG. 1 is a schematic view showing the system architecture of one specific embodiment of the information security system of the present invention;

FIG. 2 is a schematic view showing the connection status of one specific embodiment of the information security system of the present invention; and

FIG. 3 is a schematic view showing the hardware architecture of one specific embodiment of the secure type storage device of the present invention.

### DESCRIPTION OF MAIN COMPONENT SYMBOLS

10: Information security system

20: Secure type storage device

21: Memory module

211: Open storage space

212: Hidden storage space

22: Read and write control module

23: Encryption/decryption module

24: Authentication and authorization module

25: Processor

26: Memory chip

27: Authorization and authentication chip

28: Transport interface

30: Read/write device

300: Slot

31: Processing module

40: Mainframe

41: Management software

42: Authentication module

43: Data processing module

50: Transmission line

### DETAILED DESCRIPTION OF THE PREFERRED EMBODIMENTS

The present invention provides a secure type storage device and an information security system. The secure type storage device provides secure data storage environment, and the information security system provides comprehensive security mechanism to restrict data access status. The main feature of the secure type storage device is to respectively store the file allocation table and the encrypted physical archives in different storage spaces, and the storage details are free checked, but the physical archives do not be accessed through direct connection, to provide more applicable comprehensive protection.

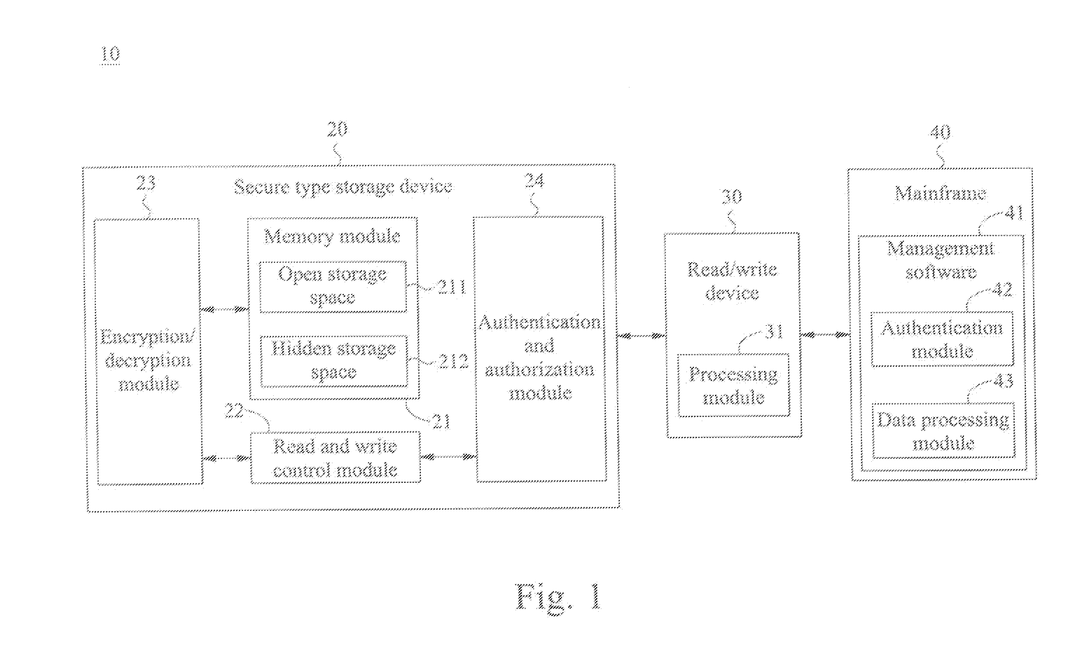

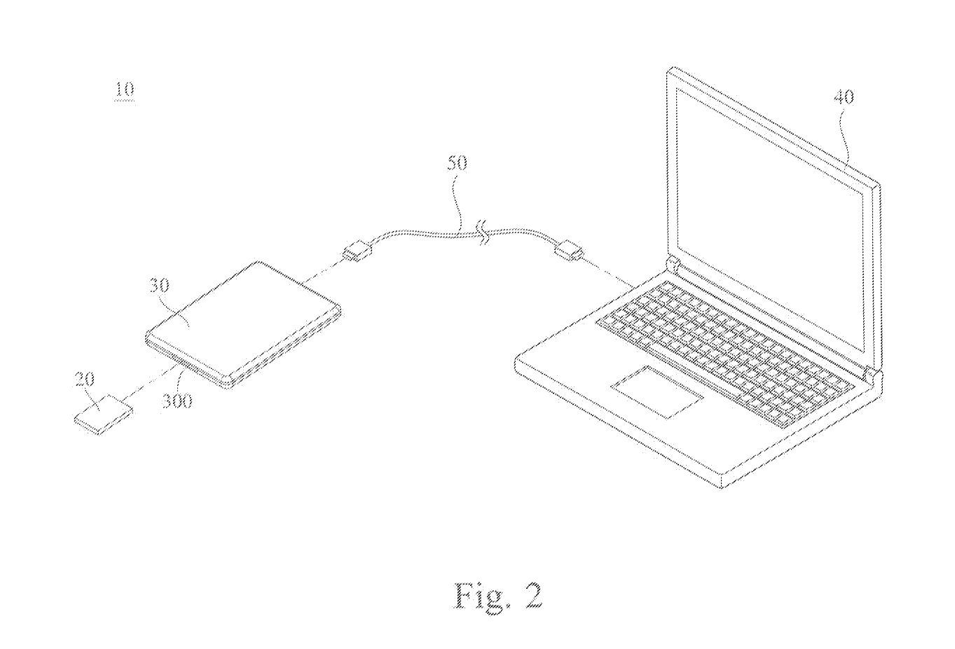

First, referring to FIG. 1 and FIG. 2, which show system architecture and connection status of one specific embodiment of the information security system of the present invention, respectively. In the drawings, a information security system 10 includes a secure type storage device 20, a read/write device 30 and a mainframe 40.

The secure type storage device 20 is specifically a flesh memory card with the specification of SD memory card (Secure Digital), CF memory card (CompactFlash), MS memory card (Memory Stick), MMC memory card (MultiMedia Card), SM memory card (Smart Media), or xD memory card (xD-Picture Card). The mainframe 40 is a computer system. The read/write device 30 is a card reader installed with a slot 300 to be plugged by the secure type storage device 20 with electrical connection through the signal terminal thereof, and is coupled to the mainframe 40 through a transmission line 50. A processing module 31 is installed within the read/write device 30 to transform the signal format, and to make the data link between the secure type storage device 20 and the mainframe 40.

As for the information security system 10 of the embodiment, the secure type storage device 20 has indirect data link with the mainframe 40 through the read/write device 30. In another embodiment, if the mainframe has the function of a card reader, the secure type storage device can directly plug in the memory slot of the mainframe.

The mainframe 40 is installed with management software 41, to link with the secure type storage device 20 for jointly implementing identity verification and data access. The management software 41 includes an authentication module 42 and a data processing module 43, in which the authentication module 42 and the secure type storage device 20 jointly implement the authentication process, and the data processing module 43 is an interface for accessing and protecting the storage device 20. The management software 41 makes more protection for data security.

The secure type storage device 20 includes a memory module 21, a read and write control module 22, an encryption/decryption module 23 and an authentication and authorization module 24. The memory module 21 includes hidden storage space 212 and open storage space 211, in which the hidden storage space 212 coordinates to store encrypted data, and the open storage space 211 coordinates to store a file allocation table registering the storage location and related property of the encrypted data.

The above features are further described as following. General file system is constituted by the file allocation table and the physical file data blocks, in which the file allocation table includes the configuration information for each file (or referred to index node), records the individual file attributes (such as file type, file owner, their group accounts, file access permissions, file size, setup time, etc.), and points to the pointer of physical data storage block. A new created file will produce two sets of data, including the file configuration information and physical archives. Each file corresponds to the file configuration information with an inode number. The file directory details will be created when a computer system reads the file allocation table.

The memory module 21 is divided into the open storage space 211 and the hidden storage space 212, which store the file allocation table and the encrypted physical archives, respectively, and the external computer free reads and creates the file directory for querying storage details, but cannot directly link and access physical archives, until the information security system 10 completes the authentication process, recognizes legal status, and obtains read/write authorization, the related links between the file allocation table and the encrypted data are established, and then the legal user can access the hidden storage space 212.

The authentication and authorization module 24 is used for data link with the mainframe 40, coordinates to jointly implement the authentication process with the authentication module 42 of the management software 41, produces the read/write authorization through handshake communication between two sides, and then provides the mainframe 40 with the access permissions. By the way, the authentication process can be implemented through ID password authentication, interactive verification of device authorization code, and fingerprint and other biometric authentication. In an embodiment, the encryption/decryption module 23 stores an identifier, the mainframe 40 stores another identifier, and two sides exchange the identifiers to certificate the legal status for each other, and to produce the read/write authorization.

Furthermore, in order to strengthen information security, the read/write device 30, coordinating to read the secure type storage device 20, has an authority, only after the secure type storage device 20 and the read/write device 30 verify the authority through handshaking, the read/write device 30 can be permitted to access the storage data.

The read and write control module 22 is the control processing core of the secure type storage device 20, and is a device communication interface, according to the read/write authorization, which responds the requirement, issued by the data processing module 42, of the mainframe 40, and issues a read out command and a write in command to the hidden storage space 212.

The encryption/decryption module 23 is a data encryption and decryption engine, and implements the data encryption and decryption in specific calculus approach. The encryption/decryption module 23 couples between the hidden storage space 212 and the read and write control module 22, for responding the read out command, to decrypt and output the encrypted data of the hidden storage space 212 to the mainframe 40 through, or for responding the write in command, to receive and encrypt the external information output by the mainframe 40, and then to store in the hidden storage space 212, in which the read and write control module 22 updates the file allocation table of the open storage space 211 on the basis of the data change of the hidden storage space 212.

In addition, the information security system 10 can further monitor the access status of the hidden storage space 212. In a specific embodiment, the management software 41 links with the read and write control module 22 during operation period, and creates a access logging within the hidden storage space 212 according to the read/write times for the mainframe 40 applying to the hidden storage space 212, when the access logging reach preset limits, the read and write control module 22 cancels the read/write authorization, and prohibits the mainframe 40 from accessing to the hidden storage space 212 to ensure data security.

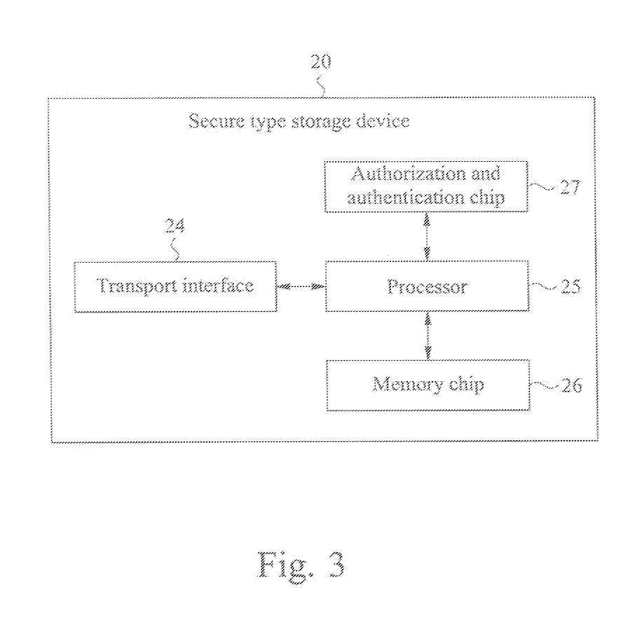

The above describes the features of the present invention by way of functional modules. Then, please refer to FIG. 3, a schematic view showing the hardware architecture of one specific embodiment of the secure type storage device of the present invention. The drawing shows simple hardware architecture of the secure type storage device 20, including a processor 25, a memory chip 26, an authorization and authentication chip 27 and a transport interface 28. The transport interface 28 is a device signal terminals group, for conduction with the internal terminal of a slot 300 of the read/write device 30 to transmit data signals. The processor 25 is a device control processing core to implement the function of the read and write control module 22. The memory chip 26 provides the open storage space 211 of the memory module 21. The hidden storage space 212, the authentication and authorization module 24 and the encryption/decryption module 23 integrate on the authorization and authentication chip 27. The authorization and authentication chip 27 is a multi-function chipset, commonly known as the smart card chip, and the mainframe 40 only passes the authentication process, and then can access the internal encrypted data, for isolating general mainframes finding the data of the hidden storage space 212, and the information security level is enhanced.

From the above, as for the secure type storage device and the information security system of the present invention, the secure type storage device has hidden storage space and open storage space for respectively storing encrypted data and a file allocation table, and the user can free check the storage details, but cannot access the encrypted data through direct connection, and the applicability of the device is improved. Next, the management software and the storage device of the mainframe jointly implement the authentication process and manage data access, which will enhance the data security level. In addition, through monitoring the read/write times applying to the hidden storage space to limit the amount of data access will further protect data security. Furthermore, the authorization and authentication chip used will isolate general mainframes finding the encrypted data, and the information security is comprehensively protected. Thus, the applicability of the information storage device is improved, and the information is prevented from being arbitrarily modified or copied and spread.

The above-mentioned are detailed explanations and drawings of specific embodiments of the present invention, which are not used for limiting the present invention, the scope of the present invention falls within the following claims, and the changes and modifications easily understood by every skilled in the art are covered within the scope of the present invention.

1. A secure type storage device applying to data connection with
a mainframe, in which the mainframe is installed with management software to jointly implement an authentication process with the secure type storage device, the secure type storage device including:
a memory module, including:
hidden storage space coordinated to store encrypted data; and
open storage space coordinated to store a file allocation table registering the storage location and property of the encrypted data; and
an authentication and authorization module, for data link with the mainframe, and coordinating with the management software to perform the authentication process, to produce a read/write authorization;
a read and write control module, in accordance with the read/write authorization, for responding the requirement of the mainframe, and issuing a read out command and a write in command to the hidden storage space; and
an encryption/decryption module, coupled between the hidden storage space and the read and write control module, for responding the read out command, and decrypting and outputting the encrypted data at the hidden storage space to the mainframe through the read and write control module, and for responding the write in command, receiving and encrypting the external information output from the mainframe, and storing in the hidden storage space, and the read and write control module modifies the file allocation table in accordance with the data change at the hidden storage space.

2. The secure type storage device as claimed in claim 1, further including a transport interface plugging in a read/write device, for indirect data connection with the mainframe through the read/write device.

3. The secure type storage device as claimed in claim 1, which is a memory card selected from one of the group composed of a SD memory card, a CF memory card, a MMC memory card, a SM memory card, a MS memory card and a xD memory card.

4. The secure type storage device as claimed in claim 1, further including an authorization and authentication chip, in which the authentication and authorization module, the encryption/decryption module and the hidden storage space integrate on the authorization and authentication chip.

5. The secure type storage device as claimed in claim 1, in which the hidden storage space stores the read/write times for the read and write control module applying to the hidden storage space, when the read/write times reach preset limits, the read and write control module cancels the read/write authorization, and prohibits the mainframe from accessing to the hidden storage space.

6. An information security system, including:
a mainframe installed with management software for performing an authentication process; and
a secure type storage device having data link with the mainframe, and the secure type storage device including:
a memory module including hidden storage space and open storage space, in which the hidden storage space coordinates to store encrypted data, and the open storage space coordinates to store a file allocation table registering the storage location and property of the encrypted data;
an authentication and authorization module, for data link with the mainframe, and coordinating with the management software to perform the authentication process, to produce a read/write authorization;
a read and write control module, in accordance with the read/write authorization, for responding the requirement of the mainframe, and issuing a read out command and a write in command to the hidden storage space; and
an encryption/decryption module, coupled between the hidden storage space and the read and write control module, for responding the read out command, and decrypting and outputting the encrypted data at the hidden storage space to the mainframe through the read and write control module, and for responding the write in command, receiving and encrypting the external information output from the mainframe, and storing in the hidden storage space, and the read and write control module updates the file allocation table in accordance with the data change at the hidden storage space.

7. The information security system as claimed in claim 6, further including a read/write device for the secure type storage device plugging in therein, and for indirect connection with the mainframe.

8. The information security system as claimed in claim 6, which is a memory card selected from one of the group composed of a SD memory card, a CF memory card, a MMC memory card, a SM memory card, a MS memory card and a xD memory card.

9. The information security system as claimed in claim 6, in which the secure type storage device further includes an authorization and authentication chip, for the authentication and authorization module, the encryption/decryption module and the hidden storage space integrating thereon.

10. The information security system as claimed in claim 6, in which the hidden storage space stores the read/write times for the read and write control module applying to the hidden storage space, when the read/write times reach preset limits, the read and write control module cancels the read/write authorization, and prohibits the mainframe from accessing to the hidden storage space.
